(19) United States
(12) Patent Application Publication
(10) Pub. No.: US 2013/0099998 A1
(43) Pub. Date: Apr. 25, 2013

(54) Three Dimensional Combo Antenna and Manufacturing Method thereof

(71) Applicants: Yu Ching Lin, Taipei (TW); Chi-Chen Chuang, Taipei (TW); Yen-Chih Chen, Taipei (TW)

(72) Inventors: Yu Ching Lin, Taipei (TW); Chi-Chen Chuang, Taipei (TW); Yen-Chih Chen, Taipei (TW)

(21) Appl. No.: 13/277,497

(22) Filed: Oct. 20, 2011

(51) Int. Cl. H01Q 21/00; H01P 11/00

(52) U.S. Cl. 343/893; 29/600

(57) ABSTRACT

A three dimensional combo antenna having a first insulating substrate, a second insulating substrate, a first antenna and a second antenna. The first insulating substrate has a first surface and a second surface opposite to the first surface. The second insulating substrate, perpendicular to the first insulating substrate is positioned on the first surface. The first antenna, formed on the first insulating substrate, is coupled to a first ground. The second antenna, formed on the second insulating substrate, is coupled to a second ground that is different from the first ground. The first and the second antennas operate at a first frequency band.

### FIELD OF THE INVENTION

The invention relates to an antenna and, and more particularly to a three dimensional combo antenna and method of manufacturing the same.

### BACKGROUND

Wireless technology is widely used. A user can receive or send data to and from a portable device, such as a mobile phone, a personal digital assistant (PDA) or a notebook computer, to or from another portable device or a stationary device via wireless communication. A user can also use the portable device to get the signals from satellites to determine the position of the portable device. Different standards have been established to govern these types of communications, including Wireless Local Area Network (WLAN), Global System for Mobile Communication (GSM), Wideband Code Division Multiple Access (WCDMA) and Global Position System (GPS).

A combo antenna that can operate in more than one frequency band has been recently proposed. During operation, the combo antenna is capable of transmitting signals through the WLAN channel or the WCDMA channel. However, it is quite difficult to dispose several antennas, which operated in different frequency bands in one portable device under the common design requirement of antenna isolation. Therefore, there is a need for a combo antenna to operate in different frequency bands and satisfied with the antenna isolation.

### SUMMARY

Accordingly, the invention is directed to a three dimensional combo antenna and method of manufacturing the same.

The three dimensional combo antenna, which utilizes the configuration space efficiently for the three-dimensional combo antenna and make the antennas operate normally, addresses the problem in the prior art of positioning several antennas under the common design requirement of antenna isolation.

The three dimensional combo antenna having a first insulating substrate, a second insulating substrate, a first antenna and a second antenna. The first insulating substrate has a first surface and a second surface opposite to the first surface. The second insulating substrate, perpendicular to the first insulating substrate is positioned on the first surface. The first antenna, formed on the first insulating substrate, is coupled to a first ground. The second antenna, formed on the second insulating substrate, is coupled to a second ground that is different from the first ground. The first and the second antennas operate in a first frequency band.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a perspective view of a three-dimensional combo antenna according to the invention;

FIG. 2 is another perspective view of the three-dimensional combo antenna according to the invention;

FIG. 3 is an exploded perspective view of the three-dimensional combo antenna shown in FIGS. 1 and 2;

FIG. 4 is a top view of the three-dimensional combo antenna shown in FIGS. 1 and 2;

FIG. 5 is a flowchart detailing an exemplary method of manufacturing for the three-dimensional combo antenna according to the invention.

### DESCRIPTION OF THE EMBODIMENT(S)

The following description is made for the purpose of illustrating the general principles of the invention and should not be taken in a limiting sense. The scope of the invention is best determined by reference to the appended claims.

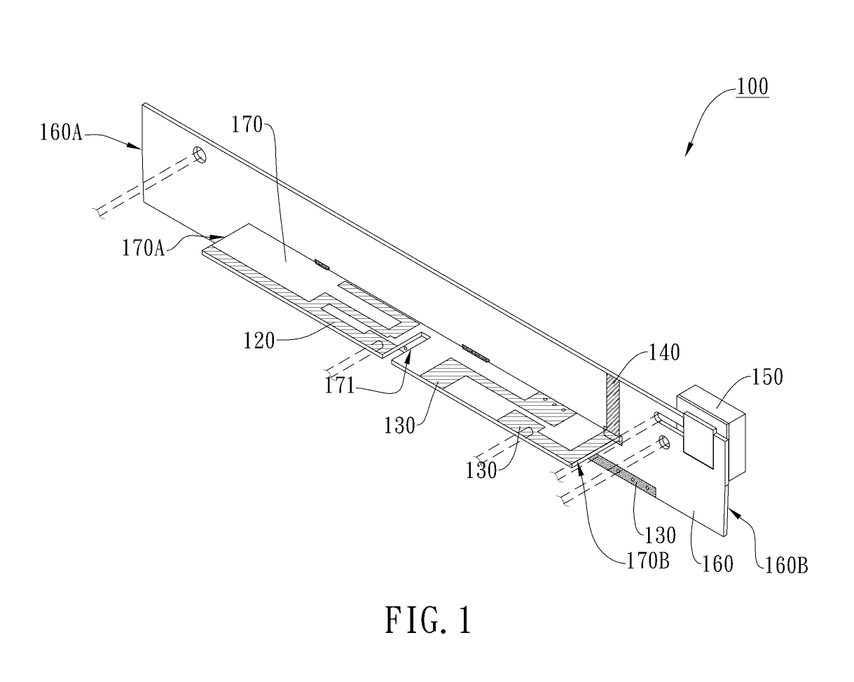

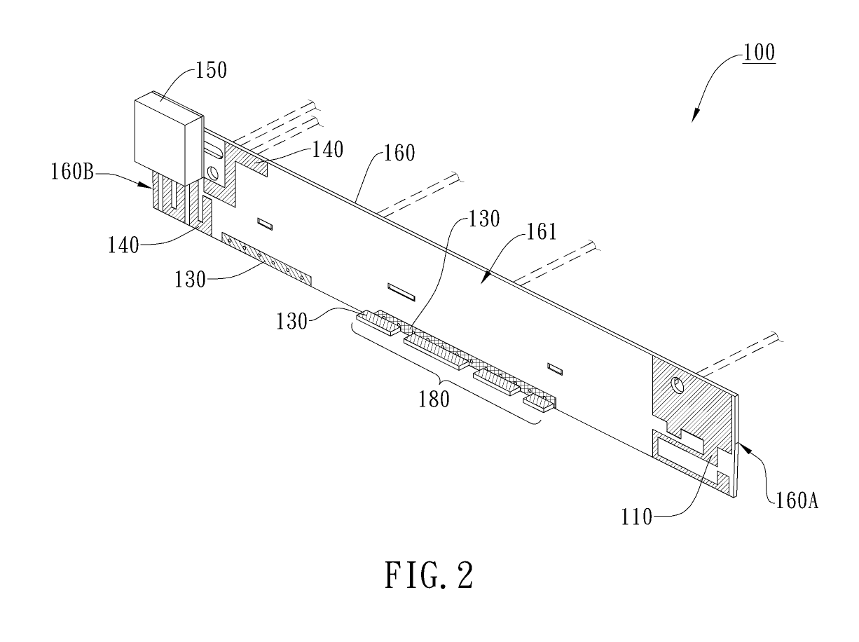

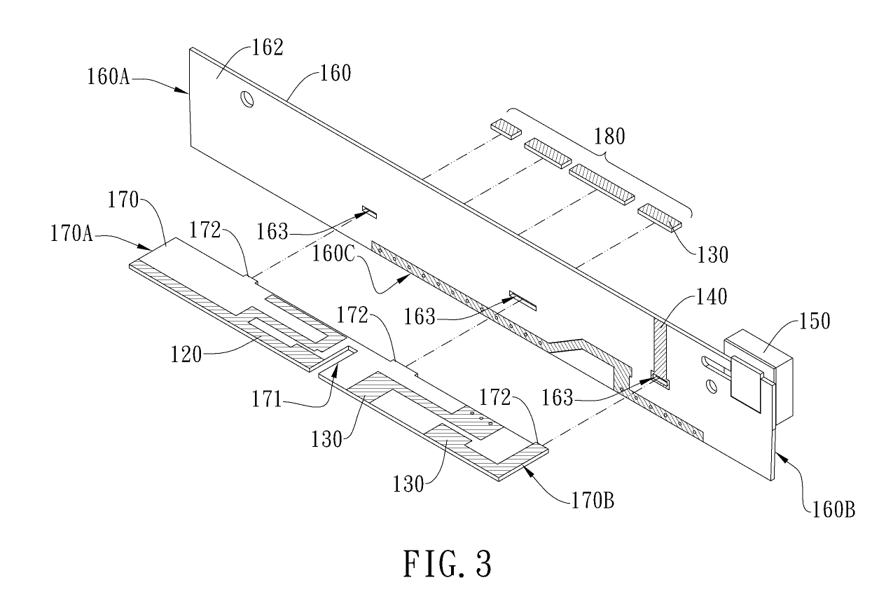

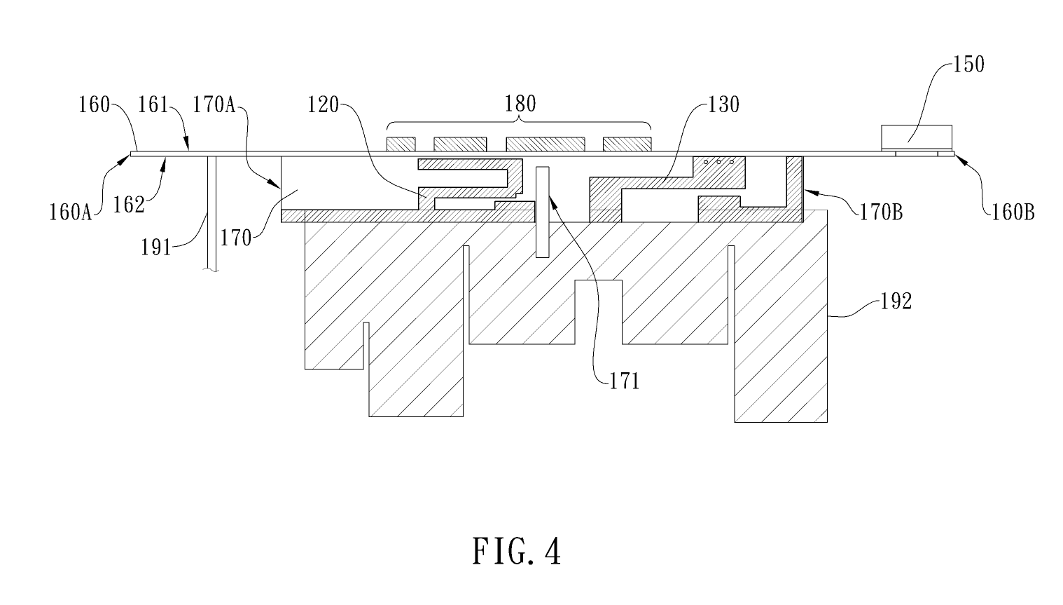

Please refer to FIG. 1 to FIG. 4, which shows an embodiment of a three-dimensional combo antenna 100 in different views according to the invention. The three-dimensional combo antenna 100 includes a first insulating substrate 160, a second insulating substrate 170, a first antenna 110, a second antenna 120, a first ground 191 and a second ground 192. In one embodiment, the three-dimensional combo antenna 100 may further include a third antenna 130, a fourth antenna 140 and a fifth antenna module 150.

The first insulating substrate 160 has a first surface 161 and a second surface 162 positioned opposite to the first surface 161. The second insulating substrate 170 is positioned on the first surface 161 and perpendicular to the first insulating substrate 160. In one embodiment, the first insulating substrate 160 further includes three receiving passageways 163, while the second insulating substrate 170 includes a notch 171 and three protuberances 172 corresponding to the three receiving passageways 163 separately. The second insulating substrate 170 may be positioned on the first insulating substrate 160, wherein the protuberances 172 pass through the receiving passageways 163 and secured using a fillet weld method.

The first antenna 110 is formed on the first insulating substrate 160 and coupled to the first ground 191. The second antenna 120 is positioned on the second insulating substrate 170 and coupled to a second ground 192, which is different from the first ground 191. The first and the second antennas 110 and 120 operate at a first frequency band. In one embodiment, the first antenna 110 may be formed on the first surface 161 of the first insulating substrate 160. However, the invention is not limited to the structure and FIGS. 1-4, and the first antenna 110 may be formed on the second surface 162 of the first insulating substrate 160.

As a result, in the prior art, two antennas, such as MAIN and AUX, should be formed in a particular interval to prevent the power of signal transmitted from the MAIN antenna affecting the reception performance of AUX antenna. However, by positioning the first antenna 110 and the second antenna 120 in two planes perpendicular to each other and grounding these two antennas through different grounds, the first and second antennas 110, 120 may be positioned adjacent to each other, yet still operate normally, which solves the problem in the prior art.

In one embodiment, the first and the second insulating substrate 160 and 170 are rectangular in shape and the extending directions of the first and the second insulating substrates 160 and 170 are parallel to each other. The first insulating substrate 160 has a first and a second sides 160A and 160B, while the second insulating substrate 170 has a third and fourth sides 170A and 170B, with the first side 160A of the first insulating substrate 160 positioned adjacent with the third side 170A of the second insulating substrate 170. In an exemplary embodiment, the first antenna 110 may be formed on a portion of the first side 160A of the first insulating substrate 160, and the second antenna 120 may be formed on a portion of the third side 170A, adjacent with the first side 160A since the first and the second antennas 110, 120 are positioned along two planes that are perpendicular to each other and grounded using different grounds.

The third antenna 130 is positioned on the first and the second insulating substrates 160 and 170 and coupled to the second ground 192. The fourth antenna 140 is positioned on the second insulating substrate 170 and coupled to the second ground 192. By positioning the third and the fourth antennas 130 and 140 in two planes perpendicular to each other, the third antenna 130 and the fourth antenna 140 may operate at a same frequency band, such as second frequency band. However, in one embodiment, the third antenna 130 may be further formed on the second insulating substrates 170 to enhance reception performance.

In one embodiment, the third antenna 130 may be formed on the second surface 162 of the first insulating substrate 160, and the fourth antenna 140 is positioned on the first surface 162. However, in another embodiment, the fourth antenna 140 may be formed on the first and the second surfaces 161 and 162, wherein the fourth antenna 140 is positioned on the second surface 162 and used for grounding through the second ground 192.

In one embodiment, the third antenna 130 is positioned on a portion of the fourth side 170B of the second insulating substrate 170 and the center portion of the second surface 162 of the first insulating substrate 160.

The fifth antenna module 150, such as a module used to operate in a particular frequency band such as 1575.42 MHz, includes at least one antenna formed on a plate and/or other electrical element, such as a low noise amplifier (LNA) such that the fifth antenna module 150 is an Active GPS antenna module. The fifth antenna module 150 is positioned on the first insulating substrate 160 and coupled to the second ground 192, the fifth antenna module 150 operates at a third frequency band. The fifth antenna module 150 is positioned on a portion of the second side 160B of the first insulating substrate 160, and the fourth antenna 140 is positioned between the third antenna 130 and the fifth antenna module 150.

In one embodiment, the three-dimensional combo antenna 100 may further include a third insulating substrate 180, which is perpendicular to the first insulating substrate 160 and disposed on the second surface 162 of the first insulating substrate 160; wherein the third antenna 130 may be further formed on the third insulating substrate 180 to enhance the reception performance. In one embodiment, the second and the third insulating substrates 170 and 180 are disposed on the first insulating substrate 160 by mounting, adhering or soldering.

The second ground 192, such as the Copper Foil, couples to and grounds the second, the third, the fourth antennas 120, 130, and 140 and the fifth antenna module 150.

The first insulating substrate 160 may further have a fifth side 160C, and the third insulating substrate 180 disposed on the lateral side of the fifth side. In one embodiment, the third insulating substrate 180 has at least four sub-substrates.

The first and the second antennas 110 and 120, in one embodiment, are used for receiving WLAN signal, for example, the first antenna 110 is the MAIN antenna and the second antenna 120 is AUX antenna. The third and the fourth antennas 130 and 140, in one embodiment, are used for receiving WCDMA/CDMA2000/TD-SCDMA signal, for example, the third antenna is MAIN antenna and the fourth antenna is AUX antenna. The fifth antenna module, in one embodiment, is used for receiving GPS/Galileo/GLONASS signal.

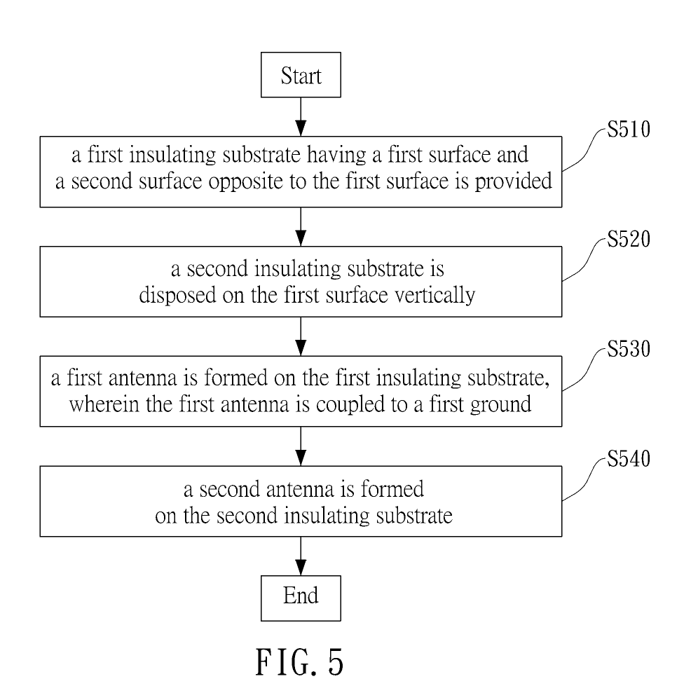

With reference to FIG. 5, a flowchart is shown, providing an exemplary method for manufacturing a three-dimensional combo antenna 100 according to the invention. Certain details and features have been left out of flowchart of FIG. 5 that are apparent to a person of ordinary skill in the art. For example, a procedure may consist of one or more sub-procedures or may involve specialized equipment or materials, as known in the art. While procedure S510 through S540 shown in the flowchart in FIG. 5 are sufficient to describe an exemplary embodiment of the invention, while other embodiments of the invention may utilize procedures different from those shown in flowchart in FIG. 5.

Please also refer to FIGS. 1-4. In step S510, a first insulating substrate 160 having a first surface 161 and a second surface 162 opposite to the first surface 161 is provided. In step S520, a second insulating substrate 170 is positioned on the first surface 161 vertically. In step S530, a first antenna 110 is positioned on the first insulating substrate 160, wherein the first antenna 110 is coupled to a first ground 191. In step S540, a second antenna 120 is positioned on the second insulating substrate 170, wherein the second antenna 120 is coupled to a second ground 192 that is different from the first ground 191. In one embodiment, the first and the second antennas 110 and 120 operate at a first frequency band.

In one embodiment, the method may further include a step of positioning a third antenna 130 on the first and the second insulating substrates 160, 170, wherein the third antenna 130 is coupled to the second ground 192 and operates at a second frequency band. The disclosed method may further include a step of positioning a fourth antenna 140 on the second insulating substrate 170, wherein the fourth antenna 140 couples to the second ground 192 and operates at a second frequency band. Also, the disclosed method may further include a step of disposing a fifth antenna module 150 on the first insulating substrate 160, wherein the fifth antenna module 150 couples to the second ground 192 and operates at a third frequency band.

In one embodiment, the method may further include the step of positioning a third insulating substrate 180 on the second surface 160B of the first insulating substrate 160 vertically.

While the disclosure has been described by way of example and in terms of the exemplary embodiment(s), it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A three-dimensional combo antenna, comprising:
a first insulating substrate having a first surface and a second surface positioned opposite the first surface;
a second insulating substrate positioned on and perpendicular to the first surface of the first insulating substrate;
a first antenna positioned on the first insulating substrate and coupled to a first ground; and
second antenna positioned on the second insulating substrate and coupled to a second ground different from the first ground;
wherein the first and the second antennas operate at a first frequency band.

2. The three-dimensional combo antenna according to claim 1, wherein the first and the second insulating substrates are rectangular.

3. The three-dimensional combo antenna according to claim 1, wherein the first insulating substrate includes a first side and a second side while the second insulating substrate includes a third side and a fourth side, the first side positioned adjacent to the third side.

4. The three-dimensional combo antenna according to claim 3, wherein the first antenna is positioned on a portion of the first side of the first insulating substrate and the second antenna is positioned on a portion of the third side of the second insulating substrate.

5. The three-dimensional combo antenna according to claim 4, further comprising a third antenna positioned on the first and the second insulating substrates and coupled to the second ground, the third antenna operates at a second frequency band.

6. The three-dimensional combo antenna according to claim 5, wherein the third antenna is positioned on a portion of the fourth side of the second insulating substrate and a center portion of the first insulating substrate.

7. The three-dimensional combo antenna according to the claim 5, further comprising a fourth antenna positioned on the second insulating substrate and coupled to the second ground, the fourth antenna operates at the second frequency band.

8. The three-dimensional combo antenna according to claim 7, further comprising a fifth antenna module positioned on the first insulating substrate and coupled to the second ground, the fifth antenna module operates at a third frequency band.

9. The three-dimensional combo antenna according to claim 8, wherein the first and the second antennas receive WLAN signals, the third and the fourth antennas receive WCDMA/CDMA2000/TD-SCDMA signals, and the fifth antenna module receives GPS/Galileo/GLONASS signals.

10. The three-dimensional combo antenna according to claim 8, wherein the fifth antenna module includes a LNA unit

11. The three-dimensional combo antenna according to claim 10, wherein the fifth antenna module is an Active GPS antenna module.

12. The three-dimensional combo antenna according to claim 8, wherein the fifth antenna module is disposed on a portion of the second side of the first insulating substrate, and the fourth antenna is positioned between the third antenna and the fifth antenna module.

13. The three-dimensional combo antenna according to claim 5, further comprising a third insulating substrate positioned on and perpendicular to the second surface of the first insulating substrate.

14. The three-dimensional combo antenna according to claim 13, wherein the third antenna is further positioned on the third insulating substrate.

15. The three-dimensional combo antenna according to claim 14, wherein the first insulating substrate further includes a fifth side, and the third insulating substrate is positioned on the lateral side of the fifth side.

16. A method of manufacturing a three-dimensional combo antenna, comprising:
providing a first insulating substrate having a first surface and a second surface positioned opposite the first surface;
positioning a second insulating substrate on and perpendicular to the first surface of the first insulating substrate vertically;
positioning a first antenna on the first insulating substrate and coupling it to a first ground; and
positioning a second antenna on the second insulating substrate and coupling it to a second ground different from the first ground;
wherein the first and the second antennas operate at a first frequency band.

17. The three-dimensional combo antenna according to claim 16, wherein the first and the second insulating substrates are rectangular.

18. The three-dimensional combo antenna according to claim 16, wherein the first insulating substrate includes a first side and a second side while the second insulating substrate includes a third side and a fourth side, the first side positioned adjacent to the third side.

19. The three-dimensional combo antenna according to claim 18, wherein the first antenna is positioned on a portion of the first side of the first insulating substrate and the second antenna is positioned on a portion of the third side of the second insulating substrate.

20. The three-dimensional combo antenna according to claim 19, further comprising a step of positioning a third antenna on the first and the second insulating substrates and coupled to the second ground, the third antenna operates at a second frequency band.

21. The three-dimensional combo antenna according to claim 20, wherein the third antenna is positioned on a portion of the fourth side of the second insulating substrate and a center portion of the first insulating substrate.

22. The three-dimensional combo antenna according to the claim 20, further comprising a step of positioning a fourth antenna on the second insulating substrate and coupled to the second ground, the fourth antenna operates at the second frequency band.

23. The three-dimensional combo antenna according to claim 22, further comprising a step of positioning a fifth antenna module positioned on the first insulating substrate and coupled to the second ground, the fifth antenna module operates at a third frequency band.

24. The three-dimensional combo antenna according to claim 23, wherein the first and the second antennas receive WLAN signals, the third and the fourth antennas receive WCDMA/CDMA2000/TD-SCDMA signals, and the fifth antenna module receives GPS/Galileo/GLONASS signals.

25. The three-dimensional combo antenna according to claim 23, wherein the fifth antenna module includes a LNA unit

26. The three-dimensional combo antenna according to claim 10, wherein the fifth antenna module is an Active GPS antenna module.

27. The three-dimensional combo antenna according to claim 23, wherein the fifth antenna module is disposed on a portion of the second side of the first insulating substrate, and the fourth antenna is positioned between the third antenna and the fifth antenna module.

28. The three-dimensional combo antenna according to claim 23, further comprising a step of positioning a third insulating substrate on and perpendicular to the second surface of the first insulating substrate.

29. The three-dimensional combo antenna according to claim 28, wherein the third antenna is further positioned on the third insulating substrate.

30. The three-dimensional combo antenna according to claim 29, wherein the first insulating substrate further includes a fifth side, and the third insulating substrate is positioned on the lateral side of the fifth side.
